(19) United States
(12) Patent Application Publication
(10) Pub. No.: US 2017/0238483 A1
(43) Pub. Date: Aug. 24, 2017

(54) Continuous Micro-irrigation Tubing and its Making Method, Using Method, and Application

(71) Applicant: SHENZHEN MOISTUBE IRRIGATION TECH. CO., LTD., Shen Zhen City, Guangdong (CN)

(72) Inventor: Qingli Yang, Guangdong (CN)

(21) Appl. No.: 15/102,101

(22) PCT Filed: May 4, 2015
(86) PCT No.: PCT/CN2015/078176

§ 371 Date: Jun. 6, 2016

(30) Foreign Application Priority Data
Jun. 6, 2014 (CN) 201410251132.1

(51) Int. Cl. A01G 25/06; A01G 25/16; B29D 23/00; B29B 9/16; B29B 7/00; B05B 1/20; B29B 11/10

(52) U.S. Cl. CPC A01G 25/06; B05B 1/20; A01G 25/167; B29B 11/10; B29B 9/16; B29B 7/002; B29D 23/00; B29B 2009/163; B29K 2023/06; B29K 2105/16

(57) ABSTRACT

The embodiments of the present application provide a method for making continuous micro-irrigation tubing, the continuous micro-irrigation tubing so made, a method for performing irrigation using the said continuous micro-irrigation tubing, and the application of the said continuous micro-irrigation tubing in agricultural irrigation, wherein the method for making continuous micro-irrigation tubing comprises: preconditioning a filler; blending the preconditioned filler with high-pressure polyethylene resin at a predefined weight ratio and making said filler and resin into filler pellet; making preformed tubing from the filler pellet; and threading the preformed tubing into a high-temperature extractor in which continuous extraction is performed to make continuous micro-irrigation tubing. The method enables the making of continuous micro-irrigation tubing containing micro-pores on the tubing wall. After the continuous micro-irrigation tubing is filled with water, water exudes through the micro-pores.

### TECHNICAL FIELD

The present application is related to the field of irrigation, in particular to a continuous micro-irrigation tubing and its making method, the method for performing irrigation using the continuous micro-irrigation tubing, and the application of the continuous micro-irrigation tubing in agricultural irrigation.

### BACKGROUND OF THE INVENTION

The history of irrigation technology is almost as long as that of agricultural civilization of human. In several thousand years of development, people commonly used four irrigation methods, i.e.: surface irrigation (including the flooding irrigation methods of canal irrigation, check irrigation, etc.), drip irrigation, sprinkling irrigation, and infiltrating irrigation. All these four irrigation methods are commonly characterized by intermittent irrigation. Their operation methods generally comprise the first watering followed by an intermission for a certain time period (several hours or days); and the second watering when the water has been almost used up by crops. Irrigation is performed intermittently in such a rhythm. Intermittent irrigation has to store some water in soil for plants to use in the intermission. Therefore, the amount of water provided in each watering is far more than the amount of water needed by plants at the time.

Refer to FIG. 1, which is a sketch map illustrating how the soil water content changes when the existing intermittent irrigation method is used. It can be seen from FIG. 1 that the existing intermittent irrigation has the following disadvantages:

First, the soil water content suddenly rises to point B and exceeds the upper limit of available water capacity, or the level of field moisture capacity, after the first watering. At this time, soil contains much water but little air and crop respiration is constrained. This results in waterlogging stress, which lasts until soil water content drops to point C. The more water is supplied in the first watering, the longer it will take to drop from point B to point C, and the more harm that the waterlogging stress will do to crops.

Second, after dropping to point C, soil water content reaches the level of field moisture capacity and air content can meet the needs of respiration by crop root. Crops are normally irrigated. After that, as time goes on and crops continuously consume water, soil water content keeps dropping to point D. When it reaches the water content at capillary rupture, crops begin to suffer drought stress. In such a case, soil contains little water but much air, and crops may temporarily wilt. Photosynthesis is hindered and growth rate decelerated. This state lasts to point A′, or the time before the second watering. Therefore, the later the second watering is, the longer the drought stress will last.

Third, the time span of truly effective irrigation within an irrigation cycle of intermittent irrigation is the time period (ED) corresponding to segment CD, which is shorter than the total time span of the irrigation cycle (AA′). In other words, an irrigation cycle of intermittent irrigation consists of three time intervals: the interval of waterlogging stress (AE), the interval of normal irrigation (ED), and the interval of drought stress (DA′). Therefore, waterlogging stress and drought stress alternate once in each irrigation cycle. This is apparently unfavorable to crop growth.

In addition, the existing means of intermittent irrigation is not the one suitable to the characteristics of crops which continuously absorb water at any time.

### BRIEF SUMMARY OF THE INVENTION

A method for making continuous micro-irrigation tubing, the continuous micro-irrigation tubing so made, the method for performing irrigation using said continuous micro-irrigation tubing, and the application of said continuous micro-irrigation tubing in agricultural irrigation. One of the targets is to replace the existing means of intermittent irrigation with a means of continuous micro-irrigation. By doing so, power drive systems become unnecessary. Moreover, the amount of irrigating water is matched to the amount of water consumed by crops. As the matching better accommodates for the physiological characteristics of plants in terms of water absorption, crops are irrigated by appropriate amount of water at any time in their life cycle, thereby growing better and outputting more.

For the aforesaid target, according to one aspect of the embodiments of the present application, a method for making continuous micro-irrigation tubing is provided, comprising:

preconditioning a filler. Said preconditioning is to evenly blend the filler with a surface treatment agent by agitation so that the surface treatment agent forms an even film of oil on the surface of filler particles. The weight percentage of said surface treatment agent to the filler is (2-8):100;

blending and agitating the preconditioned filler with polyethylene resin at a predefined weight ratio and feeding said filler and resin into a pelletizer in which they are made into filler pellet;

feeding said filler pellet into a preset tube-making equipment to make preformed tubing;

threading said preformed tubing into a high-temperature extractor in which a liquid mixture of water and sodium dodecyl benzene sulfonate (SDBS) is used as extracting agent to perform continuous extraction on said preformed tubing to make said continuous micro-irrigation tubing. Micro-pores invisible to naked eyes exist on the wall of said continuous micro-irrigation tubing. The diameter of said micro-pores is 10 nm-900 nm. The number of the micro-pores is at least 100,000 per square centimeter;

Said filler adopted is an inert powder material that does not chemically react with PE material. Said surface treatment agent adopted is a water-soluble liquid surfactant of a high boiling point.

Further, said filler is one of the light calcium carbonate, heavy calcium carbonate, and ultra-fine silicon dioxide.

Further, said surface treatment agent is fatty alcohol-polyoxyethylene ether AEO-7 or fatty alcohol-polyoxyethylene ether AEO-9.

Further, the preconditioned filler is blended and agitated with polyethylene resin at a predefined weight ratio and then fed into a pelletizer to make filler pellet, comprising:

blending the preconditioned filler with high-pressure polyethylene resin at a weight ratio of (40-60):(40-60) to form a mixture;

agitating said mixture at high temperature and high speed and then at normal temperature and low speed before feeding the mixture into a twin-screw pelletizer in which air-cooled pelletizing is performed to make filler pellet.

Further, the temperature in said high-temperature extractor is 85° C.-90° C., and the weight percentage of water to sodium dodecyl benzene sulfonate (SDBS) in said liquid extracting agent is 100:(1-5);

The liquid mixture of water and sodium dodecyl benzene sulfonate (SDBS) is used as extracting agent to perform continuous extraction on said preformed tubing to make said continuous micro-irrigation tubing, comprising:

extracting with said extracting agent the oil film sandwiched between the resin phase and filler phase in said preformed tubing so that the space that is previously occupied by the oil film between the resin phase and filler phase becomes micro-pores running through the tubing wall.

Further, the thickness of said oil film is proportional to the average diameter of said micro-pores.

Further, the parts by weight of said preconditioned filler are proportional to the number of said micro-pores.

According to another aspect of the embodiments of the present application, a continuous micro-irrigation tubing made using any of the aforesaid methods is provided. No pore or void visible to naked eyes exists on the wall of said continuous micro-irrigation tubing, which appears even and smooth and does not have apparent difference from ordinary plastic tubing.

Further, the means for water to discharge out of said continuous micro-irrigation tubing is: water simultaneously exudes through all the micro-pores on the tubing wall and the entire outer surface of the wall becomes wet at the same time.

According to another aspect of the embodiments of the present application, an application of the aforesaid continuous micro-irrigation tubing in agricultural irrigation is provided.

In addition, the embodiments of the present application also provide a method for performing irrigation using the aforesaid continuous micro-irrigation tubing. Crops are so pre-configured that they are arranged in rows when being planted. Said method comprises:

burying a piece of said continuous micro-irrigation tubing at a depth of 15-35 cm in the soil under each row of crops;

connecting both ends of each piece of continuous micro-irrigation tubing to preset water supply tubes using connectors to form an irrigation network. One end of said irrigation network is connected to a water source, and said water source has an initial pressure;

supplying water to said irrigation network through said water source so that a wetted cylindrical irrigating body centering about each piece of continuous micro-irrigation tubing is formed around the continuous micro-irrigation tubing;

measuring the water content of said wetted cylindrical irrigating body for multiple times and adjusting the pressure of said water source based on the measuring result until a balanced-irrigation pressure is obtained, wherein the amount of water irrigated by the irrigation network is equal to the field water consumption by crops under said balanced-irrigation pressure;

continuously irrigating crops by means of uninterrupted supply of water on 7×24 basis based on said balanced-irrigation pressure so that the water consumed by crops at any time can be immediately made up by equal amount of water.

Further, said method also comprises: adjusting the pressure of said water source based on the field water consumption corresponding to different crops on different growth stages

Further, the water content of said wetted cylindrical irrigating body is measured for multiple times and the pressure of said water source is adjusted based on the measuring result until a balanced-irrigation pressure is obtained, comprising:

obtaining the first measuring result by measuring the water content of said wetted cylindrical irrigating body at the first preset time interval for the first preset number of times;

decreasing the water source pressure and continuing irrigation with the decreased water source pressure if the water content of said wetted cylindrical irrigating body in the first measuring result tends to rise;

obtaining the second measuring result by measuring the water content of said wetted cylindrical irrigating body at the second preset time interval for the second preset number of times;

increasing the water source pressure if the water content of said wetted cylindrical irrigating body in the second measuring result tends to drop;

repeating the aforesaid steps until the water content of said wetted cylindrical irrigating body maintains stable. The corresponding water source pressure is the balanced-irrigation pressure.

Compared to prior art, one of the aforesaid technical solutions has the following advantages:

According to the embodiment of the method for making continuous micro-irrigation tubing and the continuous micro-irrigation tubing made using the method as provided in the embodiments of the present application, continuous micro-irrigation tubing with micro-pores that are invisible to naked eyes on the tubing wall can be made. After the continuous micro-irrigation tubing is filled with water, water exudes through the micro-pores. The amount of exuded water is accurate and adjustable in order to continuously irrigate crops by means of uninterrupted supply of micro amount of water on 7×24 basis in their full life cycle. According to the embodiment of the method for performing irrigation using the aforesaid continuous micro-irrigation tubing as proposed in the embodiments of the present application, the existing means of intermittent irrigation is replaced by a means of continuous micro-irrigation. Using an approach of irrigation whereby crops are continuously irrigated by means of uninterrupted supply of micro amount of water on 7×24 basis in their full life cycle, power drive systems become unnecessary. Moreover, the matching between the amount of irrigating water and the amount of water consumed by crops better accommodates for the physiological characteristics of plants in terms of water absorption. Being irrigated by balanced amount of water at any time in their life cycle, crops grow better and output more.

### BRIEF DESCRIPTION OF THE DRAWINGS

FIG. 1 is a sketch map illustrating how the soil water content changes when the existing intermittent irrigation method is used;

FIG. 2 is the flowchart of the method for making continuous micro-irrigation tubing as provided in the embodiments of the present application;

FIG. 3 is the flowchart of the method for performing irrigation using continuous micro-irrigation tubing as provided in the embodiments of the present application;

FIG. 4 is a sketch map illustrating how the soil water content changes when irrigation is performed using the continuous micro-irrigation tubing provided in the embodiments of the present application.

### DETAILED DESCRIPTION OF THE PREFERRED EMBODIMENT

For a better understanding of the aforesaid objects, features, and advantage of the embodiments of the present application, reference is made to the following description, which is to be read in conjunction with the accompanying drawings and preferred embodiment.

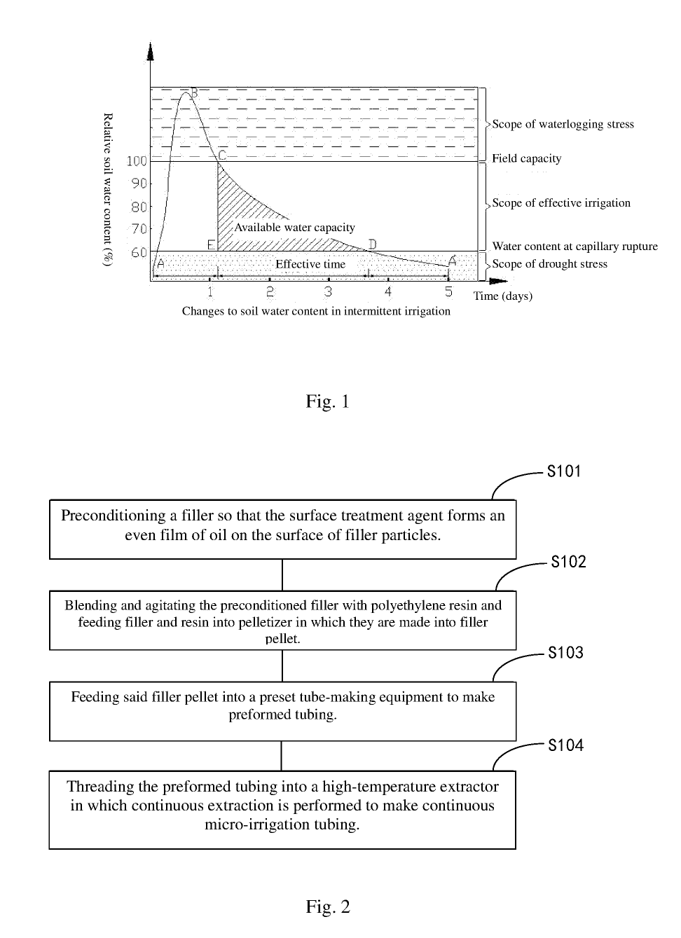

Refer to FIG. 2, which is the flowchart of the method for making continuous micro-irrigation tubing as provided in the embodiments of the present application;

In the embodiment, the method comprises the following steps:

S101—preconditioning a filler. Said preconditioning is to evenly blend the filler with surface treatment agent at a weight percentage of (2-8):100 by agitation so that the surface treatment agent is evenly distributed and forms an even film of oil on the surface of filler particles. When the filler is filled into resin, the oil film is sandwiched between filler particles and resin and works for isolation.

The adopted filler may be an inert powder material, such as light calcium carbonate, heavy calcium carbonate, or ultra-fine silicon dioxide, which does not chemically react with PE (polyethylene) material.

The adopted surface treatment agent may be a water-soluble liquid surfactant of a high boiling point, such as fatty alcohol-polyoxyethylene ether AEO. AEO-7 or AEO-9 is preferred.

S102—blending the preconditioned filler with polyethylene resin at a predefined weight ratio. If necessary, a small amount of other additives for plastic processing, such as antioxidant, UV absorbent, or lubricant, may be added. The aforesaid materials are mixed and agitated and then fed into a pelletizer in which they are made into filler pellet.

In particular, the filler preconditioned in S101 may be blended with polyethylene resin at a weight ratio of (40-60):(60-40) to form a mixture, which is agitated on two stages, one at high temperature and high speed and the other at normal temperature and low speed, before being fed into a twin-screw pelletizer in which air-cooled pelletizing is performed to make filler pellet for later use.

S103—feeding filler pellet into a preset tube-making equipment to make preformed tubing.

In particular, the step may be that the filler pellet is fed into a hot-extrusion-based tube-making equipment, in which it is extruded and molded at a temperature of 130° C.-150° C. before running through cooling, diameter setting, pulling, and other tube-making steps so that it is made into preformed tubing.

S104—threading the aforesaid preformed tubing into a high-temperature extractor in which a liquid mixture of water and sodium dodecyl benzene sulfonate (SDBS) is used as the extracting agent to perform continuous extraction on the preformed tubing to make continuous micro-irrigation tubing, on the wall of which are micro-pores invisible to naked eyes. The diameter of said micro-pores is 10 nm-900 nm. The number of the micro-pores is at least 100,000 per square centimeter.

In particular, the step may be that the aforesaid preformed tubing is threaded into a high-temperature extractor of which the temperature may be adjusted to 85° C.-90° C., and then continuously extracted with a liquid extracting agent that is a mixture of water and sodium dodecyl benzene sulfonate (SDBS) at a weight percentage of 100:(1-5). The extracting agent extracts the oil film (surfactant) sandwiched between filler particles and resin to form many tiny voids between the filler phase and resin phase. These tiny voids randomly connect to each other to form irregular channels. If one end of a channel is on the internal side of the tubing wall and the other end is on the external side of the wall, it becomes a micro-pore running through the wall. These micro-pores are randomly formed anywhere along the wall of the entire continuous micro-irrigation tubing.

The number of these micro-pores is proportional to the parts by weight of the preconditioned filler. For example, if the parts by weight of the preconditioned filler is 40%, or the preconditioned filler is blended with polyethylene resin at a weight ratio of 40:60 to form a mixture, the number of ultimately formed micro-pores is about 100,000 per square centimeter; and if the parts by weight of the preconditioned filler is 60%, or the preconditioned filler is blended with polyethylene resin at a weight ratio of 60:40 to form a mixture, the number of ultimately formed micro-pores is more than 100,000 per square centimeter. This means that more micro-pores will be formed if the preconditioned filler is more.

The diameter of the micro-pores is proportional to the thickness of oil film. If more surface treatment agent is used, the oil film will be thicker and the average diameter of the micro-pores formed from extraction will be larger.

Therefore, the amount of preconditioned filler and the amount of surface treatment agent may be appropriately adjusted pursuant to the practical needs to control the number and average diameter of the micro-pores on the continuous micro-irrigation tubing.

No pore or void visible to naked eyes exists on the wall of the continuous micro-irrigation tubing made using the aforesaid method. The tubing appears even and smooth and does not have apparent difference from ordinary plastic tubing. However, micro-pores with the diameter of 10 nm-900 nm are distributed everywhere on the wall of the tubing, as detected by electron microscopes.

The continuous micro-irrigation tubing features its own means for water to discharge out of it; that is, after the continuous micro-irrigation tubing is filled up with water, water is not seen flowing or dripping out of any micro-pore; instead, it simultaneously exudes through all the micro-pores on the tubing wall and the entire outer surface of the wall becomes wet at the same time.

The continuous micro-irrigation tubing has the following advantages:

1. Because of the aforesaid means for water to discharge out of the continuous micro-irrigation tubing, the tubing supplies water as a linear source when it is used for irrigation. As compared to the existing drip irrigation tubes that supply water as point sources, it can be used to irrigate not only individual plants but also closely planted ones (such as wheat).

2. After the continuous micro-irrigation tubing is connected to water supply, water slowly exudes through the micro-pores on the tubing wall without any power drive. Therefore, as long as it exists in an irrigation system built with the continuous micro-irrigation tubing, water automatically exudes to soil through tubing wall without any power drive at all. This addresses the cost issue resulting from the power drive essential to the existing micro-irrigation systems.

3. Multiple tests have determined that the amount of water exuded by the continuous micro-irrigation tubing per unit time is in a sound linear relationship with the pressure: Y=Ax+B.

Where, Y is the amount of water exuded per unit time (ml/m·h); X is the pressure (m), and A and B are characteristic coefficients related to soil property.

In clay soil, A=64.844 and B=25.613, so Y=64.844x+25.613, with the coefficient of determination R²=0.9953.

It can be seen that the amount of water exuded by the continuous micro-irrigation tubing per unit time is so low that it has to be measured in the unit of milliliter and is extremely sensitive to pressure. According to the aforesaid formula, the amount of water exuded by the continuous micro-irrigation tubing per unit time increases by 3.2 ml once the pressure increases by 0.05 m. The scale of such a precision of water supply is comparative to the scale of water consumed by crops per unit time. Therefore, the amount of water supplied by the irrigation system may be adjusted to provide precisely equal make-up to the water consumed by the crop field system, and thereby continuously irrigating crops without interruption.

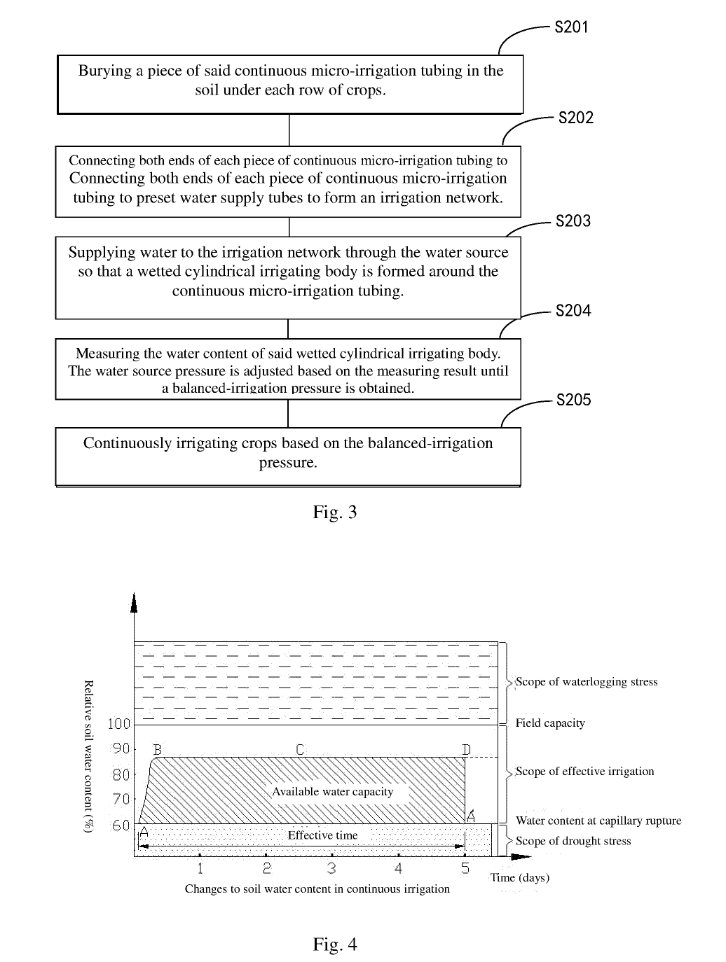

Refer to FIG. 3, which is the flowchart of the method for performing irrigation using the aforesaid continuous micro-irrigation tubing as provided in the embodiments of the present application.

In the embodiment, crops are so pre-configured that they are arranged in rows when being planted. The method comprises:

S201—burying a piece of continuous micro-irrigation tubing at a depth of 15-35 cm in the soil under each row of crops.

S202—connecting both ends of each piece of continuous micro-irrigation tubing to preset water supply tubes using connectors to form an irrigation network. Moreover, one end of said irrigation network is connected to a water source (e.g. a water tank). The water source has a certain initial pressure (e.g. 2 m), which can be set pursuant to the factors of soil, crop, and climate conditions.

S203—supplying water to the irrigation network through the water source so that a wetted cylindrical irrigating body centering about each piece of continuous micro-irrigation tubing is formed around the continuous micro-irrigation tubing. Crops can be irrigated by absorbing water from the wetted cylindrical irrigating body.

S204—measuring the water content of said wetted cylindrical irrigating body for multiple times. The water source pressure is adjusted based on the measuring result until a balanced-irrigation pressure is obtained, wherein the amount of irrigating water supplied by the irrigation network under said balanced-irrigation pressure is equal to the field water consumption by crops.

In particular, the step may comprise:

The water content of the wetted cylindrical irrigating body is measured at the first preset time interval for the first number of times to obtain the first measuring result. For example, if the first preset time interval is 24 hours and the first preset number of times is 3, then the water content of the wetted cylindrical irrigating body should be first measured once at the beginning, and then once in 24 hours and 48 hours, respectively. The first measuring result includes 3 water content values.

If the water content of said wetted cylindrical irrigating body in the first measuring result tends to rise, or, the value of a later measurement is always higher than that of a previous measurement, the amount of irrigating water is higher than the field water consumption (field evaporation) by crops in the time period. As a result, water continuously accumulates in the soil and the soil water content gradually increases. In such a case, it is necessary to decrease the water source pressure (e.g., adjust the water in the water tank from 2 m to 1.5 m) and continue the irrigation with the decreased pressure in order to reduce the amount of irrigating water.

The water content of the wetted cylindrical irrigating body is measured at the second preset time interval for the second preset number of times to obtain the second measuring result. For example, if the second preset time interval is 24 hours and the second preset number of times is 4, then the water content of the wetted cylindrical irrigating body should be first measured once at the beginning, and then once in 24 hours, 48 hours, and 72 hours, respectively. The second measuring result includes 4 water content values.

If the water content of said wetted cylindrical irrigating body in the second measuring result tends to drop, or, the value of a later measurement is always lower than that of a previous measurement, the pressure has been so adjusted a little too much that the amount of irrigating water is less than the field water consumption by crops and is insufficient to make up the water consumed by the crops. In such a case, it is necessary to slightly re-increase the water source pressure (e.g., adjust the water in the water tank from 1.5 m to 1.6 m).

The aforesaid steps of measurement and adjustment are repeated until the data of water content of the wetted cylindrical irrigating body obtained from multiple measurements are generally on the same level. This indicates that the amount of irrigating water supplied is equal to the field water consumption by crops and the corresponding water source pressure is the balanced-irrigation pressure. In such a case, water in the soil is under a balance between income and expenditure, and is neither surplus nor insufficient; and the soil water content does not change over time.

S205—Continuously irrigating crops by means of uninterrupted supply of water on 7×24 basis under the balanced-irrigation pressure so that the water consumed by crops at any time can be immediately made up by equal amount of water.

Refer to FIG. 4, which is a sketch map illustrating how the soil water content changes when irrigation is performed using the continuous micro-irrigation tubing provided in the embodiments of the present application. FIG. 4 indicates that:

1. After measurement and adjustment, the water source pressure is maintained at the balanced-irrigation pressure and the soil water content reaches point B. Moreover, irrigation is maintained under the balanced-irrigation pressure for a certain time period afterwards. The soil water content is kept at the same level and will not significantly fluctuate over time.

2. When irrigation is performed using the irrigation method provided in the embodiments of the present application, the curve of soil water content always falls within the scope of effective irrigation in the time period that is as long as the cycle of the existing intermittent irrigation. That is to say, the time period of effective irrigation of the irrigation method is almost as long as the time period in which the irrigation is performed. Moreover, the time period does not contain any time of waterlogging stress or drought stress. Therefore, the irrigation method can be called a stress-free method.

3. When irrigation is performed using the irrigation method of the present application, almost all the water in soil is available. Therefore, the method is an irrigation method that efficiently utilizes water. Its effect of water conservancy is apparently better than the existing intermittent irrigation.

Therefore, with the method for performing irrigation using continuous micro-irrigation tubing, the water consumed by crops will be immediately made up by the irrigation system. Water in soil will be neither so much that crops are under waterlogging stress nor so little that the crops are under drought stress. Therefore, this irrigation method whereby the amount of irrigating water is balanced with the amount of water consumed by crops may be also referred to as balanced irrigation. It has been practically proven that such a balanced state can be maintained relatively stable for a certain time period, such as 10-15 days, under a certain condition of soil and climate.

With the grow-up of crops and rise of temperature, the farm water consumption gradually increases. As a result, soil water content tends to drop and the aforesaid balance may tend to be broken after a certain time period (such as 10-15 days). To resume and maintain balance, the same steps of measurement and adjustment as above may be performed to adjust the pressure (e.g., by increasing the water in water tank from 1.6 m up to 1.65 m) so that balance is established between irrigating water supply, soil water content, and water consumption by plants on a new level. Moreover, water source pressure may be adjusted stage-wisely pursuant to the characteristics that different crops correspond to different field water consumption on different stages of growth, in order to reach the balance suitable to each stage. By doing so, stage-specific balances that come one after another are established in the full life cycle of crops; and balanced irrigation throughout the process from seeding to harvesting, as well as continuous micro-irrigation in the full life cycle, are realized.

Moreover, the embodiments of the present application provide an application of the aforesaid continuous micro-irrigation tubing in agricultural irrigation.

The method for making continuous micro-irrigation tubing, the continuous micro-irrigation tubing so made, and the method for performing irrigation using said continuous micro-irrigation tubing as provided in the embodiments of the present application will be explained with reference to the following examples.

### EXAMPLE 1

1. Light calcium carbonate is adopted as the filler, which is preconditioned using AEO surface treatment agent, of which the weight percentage to the filler is 8:100.

2. The preconditioned filler is blended with PE resin at a weight ratio of 60:40 and then pelletized.

3. The produced pellet is fed into a tube-making production line, in which it is made into preformed tubing of the required diameter through extrusion, cooling, diameter setting, and pulling.

4. The preformed tubing is threaded into a continuous high-temperature extractor, wherein it is continuously extracted with a liquid extracting agent comprising water and sodium dodecyl benzene sulfonate (SDBS) of 100:1 in weight percentage under a temperature of 85° C. After being cooled, it is made into continuous micro-irrigation tubing.

It has been determined that the amount of water exuded by the continuous micro-irrigation tubing is 170 ml/m·h. Therefore, the continuous micro-irrigation tubing is of a high-water-discharge type and is suitable to perform continuous micro-irrigation to crops of high water consumption.

The method features high dosage of AEO surface treatment agent (8%), which forms thick oil film on the surface of filler particles. Therefore, large voids are left after extraction, leading to large-diameter micro-pores on the continuous micro-irrigation tubing. With the pore diameter in the range of 10-900 nm, the tubing is suitable to most crops in normal situations.

### EXAMPLE 2

The only difference from the steps described in Example 1 is that the preconditioned filler is blended with PE resin at a weight ratio of 40:60 before being pelletized.

It has been determined that the amount of water exuded by the continuous micro-irrigation tubing made using the method is 80 ml/m·h. Therefore, the continuous micro-irrigation tubing is of a low-water-discharge type and is suitable to perform continuous micro-irrigation to crops of low water consumption.

### EXAMPLE 3

The dosage of AEO surface treatment agent in the aforesaid Example 1 is reduced to 2% (i.e., its weight percentage to filler is 2:100).

It is determined that the continuous micro-irrigation tubing made using the method has small micro-pore diameters. The range in which the diameters are distributed is reduced down to 10-300 nm. Since the diameter of discharge channels is reduced, the amount of water exuded by the continuous micro-irrigation tubing per unit time drops to 20-30 ml/m·h under the pressure of 2 m. Higher water source pressure is needed to increase the amount of exuded water. Therefore, this type of continuous micro-irrigation tubing is suitable to the scenario where tap water is the water source and the high pressure of the source is used for the irrigation of, for example, home gardens.

### EXAMPLE 4

Assume that a plot of farmland used to plant tomatoes is 50 m long and 24 m wide, where tomatoes are planted in 30 rows that are 0.8 m away from each other. A water tank is used as the water source. The continuous micro-irrigation tubing provided by the embodiments in the present application is used as the water feeder.

The irrigation method is as follows:

1. Thirty ditches that are 0.15 m deep and 50 m long for each and 0.80 m away from each other are dug longitudinally along the plot.

2. The continuous micro-irrigation tubing is sheared into 30 pieces that are 50 m long for each. The pieces are laid flat in the ditches, one for each ditch.

3. Both ends of each piece of continuous micro-irrigation tubing are connected to the water supply tubes using pipe fittings to form a ladder-shaped field irrigation network.

4. The irrigation network is connected to the water tank. After the continuous micro-irrigation tubing is filled up with water, the water discharge of the field irrigation network is checked before soil is backfilled to bury the tubing. After seeding or transplantation, irrigation is performed at 2.00 m water level in the water tank.

5. The soil water content in the wetted body is measured. In the initial measurement, the soil water content is 18%. Then the measurement is performed for three times, once every 24 hours afterwards, giving three soil water content values of 20%, 22%, and 24%, respectively.

Because the soil water content increases day by day, the amount of irrigating water per day is more than the amount of water daily consumed by crops. As a result, water will accumulate in the soil over days. This is unfavorable to crop growth and if no adjustment were made, the crops would be subject to waterlogging. Therefore, it is necessary to decrease the water source pressure.

6. The water level in the water tank is decreased to 1.0 m. The water content is measured by following the aforesaid steps. It is found that the soil water content drops day by day when the system pressure is maintained at 1.50 m. This indicates that this adjustment is excessive and the amount of irrigating water is insufficient to make up the amount of water consumed by crops. Therefore, it is necessary to increase the water source pressure.

7. After several cycles of measurement and adjustment in the pressure range of 1.50 m-2 m, it is found that the measured soil water content is generally stabilized at around 20% in several days after the water tank pressure reaches 1.60 m. This indicates that the water consumed by evaporation in the tomato farmland is equally made up by the irrigation system under the climate and temperature condition at that time. In such a time period, water in the soil is under a balance between income and expenditure, and is in an excellent state in which it is neither surplus nor insufficient. Therefore, the determined balanced-irrigation pressure is 1.60 m.

8. Irrigation is continued under such a balanced-irrigation pressure for a certain time period (e.g. 10 days). In these 10 days, crops are always well irrigated without waterlogging stress or drought stress.

9. With the grow-up of crops and the rise of air temperature, the field water consumption increases and the former condition of balance between supply and demand is changed. At that time, it is necessary to slightly increase the system pressure. For example, the balance pressure of 1.60 m may be increased to 1.65 m so that the amount of irrigating water slightly increases. According to a test, the newly added amount of irrigating water reaches a new balance with the increased water consumption by crops. This ensures the continuation of the sound water and air state in soil.

Such stage-wise fine adjustment may be performed for multiple times to gradually increase the water source pressure in line with the continuously increasing water consumption by crops. By doing so, the water demand by crops in different time periods is met and the crops are well irrigated in their full life cycle. The magnitude of each adjustment may be determined by measuring soil water content.

According to the method for making continuous micro-irrigation tubing as provided in the embodiments of the present application, continuous micro-irrigation tubing with micro-pores that are invisible to naked eyes on the tubing wall can be made. After the continuous micro-irrigation tubing is filled with water, water exudes through the micro-pores. The amount of exuded water is accurate and adjustable in order to continuously irrigate crops by means of uninterrupted supply of micro amount of water on 7×24 basis in their full life cycle. In the method for performing irrigation using the aforesaid continuous micro-irrigation tubing as provided in the embodiments of the present application, the existing means of intermittent irrigation is replaced by the means of continuous micro-irrigation. Using an approach of irrigation whereby crops are continuously irrigated by means of uninterrupted supply of micro amount of water on 7×24 basis in their full life cycle, power drive systems become unnecessary. Moreover, the matching between the amount of irrigating water and the amount of water consumed by crops better accommodates for the physiological characteristics of plants in terms of water absorption. Being irrigated by balanced amount of water at any time in their life cycle, crops grow better and output more.

The embodiments in the specification are all described in a progressive manner. Each embodiment is focused on its difference from other embodiments. The same or similar parts in the embodiments can be referenced mutually.

The method for making continuous micro-irrigation tubing, the continuous micro-irrigation tubing so made, the method for performing irrigation using said continuous micro-irrigation tubing, and the application of said continuous micro-irrigation tubing in agricultural irrigation as provided in the embodiments of the present application are described in details as above. The principle and preferred embodiment of the present application are described with reference to specific examples herein. The aforesaid description of the embodiments are for helping understand the methods of the present application and their core spirit only. In addition, those skilled in the art may make changes in the preferred embodiment and/or application scope based on the spirit of the present application. Therefore, the content of this description may not be construed as limitation to the present application.

1.-10. (canceled)

11. A method for making continuous micro-irrigation tubing, comprising:
wherein a filler is preconditioned by blending the filler with a surface treatment agent by agitation so that the surface treatment agent forms a film of oil on a surface of filler particles;
wherein the preconditioned filler is blended and agitated with polyethylene resin at a predefined weight ratio and feeding said filler and resin into a pelletizer in which they are made into filler pellet;
feeding the filler pellet into a preset tube-making equipment to make a preformed tubing;
threading the preformed tubing into a high-temperature extractor in which a liquid mixture of water and sodium dodecyl benzene sulfonate (SDBS) is used as extracting agent to perform continuous extraction on the preformed tubing to make the continuous micro-irrigation tubing;
wherein the filler is an inert powder material that does not chemically react with PE material,
wherein the surface treatment agent is a water-soluble liquid surfactant of a high boiling point.

12. The method of claim 11, wherein the filler is one of light calcium carbonate, heavy calcium carbonate, and ultra-fine silicon dioxide.

13. The method of claim 11, wherein: the surface treatment agent is fatty alcohol-polyoxyethylene ether AEO-7 or fatty alcohol-polyoxyethylene ether AEO-9,
wherein a dosage of surface treatment agent is proportional to a thickness of the oil film formed on the surface of the filler particles and determines an average diameter of micro-pores defined on a wall of the continuous micro-irrigation tubing.

14. The method of claim 11, wherein micro-pores are defined on a wall of the continuous micro-irrigation tubing.

15. The method of claim 14, wherein a diameter of the micro-pores is 10 nm to 900 nm.

16. The method of claim 15, wherein the number of the micro-pores is at least 100,000 per square centimeter.

17. The method of claim 14, wherein the preconditioned filler is blended and agitated with polyethylene resin at a predefined weight ratio and then fed into the pelletizer to make the filler pellet,
the method further including:
blending the preconditioned filler with high-pressure polyethylene resin at a weight ratio of (40-60):(40-60) to form a mixture;
agitating the mixture at a high temperature and a high speed and then at a normal temperature and a low speed before feeding the mixture into the pelletizer, wherein the pelletizer is air-cooled,
wherein the parts by weight of the preconditioned filler are proportional to the number of the micro-pores.

18. The method of claim 11, wherein the temperature of the high-temperature extractor is 85 to 90 degrees Celsius, the weight percentage of water to sodium dodecyl benzene sulfonate (SDBS) in the liquid extracting agent is 100:(1-5), and the liquid mixture of water and sodium dodecyl benzene sulfonate (SDBS) is used as extracting agent to perform continuous extraction on the preformed tubing to make said continuous micro-irrigation tubing,
the method further comprising:
extracting with an extracting agent oil film sandwiched between a resin phase and a filler phase in the preformed tubing so that the space that is previously occupied by the oil film between the resin phase and filler phase becomes micro-pores that extend through a wall of the tubing.

19. A continuous micro-irrigation tubing comprising:
a continuous micro-irrigation tubing that has a visual characteristic where the tubing appears about the same as plastic tubing, the tubing made from a process comprising:
wherein a filler is preconditioned by blending the filler with a surface treatment agent by agitation so that the surface treatment agent forms a film of oil on s surface of filler particles;
wherein the preconditioned filler is blended and agitated with polyethylene resin at a predefined weight ratio and feeding said filler and resin into a pelletizer in which they are made into filler pellet;
feeding the filler pellet into a preset tube-making equipment to make a preformed tubing;
threading the preformed tubing into a high-temperature extractor in which a liquid mixture of water and sodium dodecyl benzene sulfonate (SDBS) is used as extracting agent to perform continuous extraction on the preformed tubing to make the continuous micro-irrigation tubing;
wherein the filler is an inert powder material that does not chemically react with PE material,
wherein the surface treatment agent is a water-soluble liquid surfactant of a high boiling point.

20. The continuous micro-irrigation tubing of claim 19, wherein water is discharged out of the continuous micro-irrigation tubing by exuding through all the micro-pores on the tubing wall and an entire outer surface of the wall becomes wet at the same time.

21. The continuous micro-irrigation tubing of claim 19, wherein the tubing is used in agricultural irrigation.

22. A method of using a continuous micro-irrigation tubing, wherein crops are so pre-configured that they are arranged in rows when being planted, wherein the tubing is supplied by:
burying a piece of a continuous micro-irrigation tubing at a depth of 15-35 cm in the soil under each row of crops;
connecting both ends of each piece of continuous micro-irrigation tubing to preset water supply tubes using connectors to form an irrigation network. One end of said irrigation network is connected to a water source, and said water source has an initial pressure;
supplying water to said irrigation network through said water source so that a wetted cylindrical irrigating body centering about each piece of continuous micro-irrigation tubing is formed around the continuous micro-irrigation tubing;
measuring the water content of said wetted cylindrical irrigating body for multiple times and adjusting the pressure of said water source based on the measuring result until a balanced-irrigation pressure is obtained, wherein the amount of water irrigated by the irrigation network is equal to the field water consumption by crops under said balanced-irrigation pressure;
continuously irrigating crops by means of uninterrupted supply of water on 7×24 basis based on said balanced-irrigation pressure so that the water consumed by crops at any time can be immediately made up by equal amount of water.

23. The method of claim 22, further comprising: adjusting the pressure of said water source successively based on the field water consumption corresponding to different crops on different growth stages in order to create a series of balanced-irrigation periods that come one after another and to complete continuous irrigation to crops in their full life cycle.
